(19) United States
(12) Patent Application Publication
(10) Pub. No.: US 2010/0309590 A1
(43) Pub. Date: Dec. 9, 2010

(54) High Voltage Saturated Core Fault Current Limiter

(75) Inventor: Francis Anthony Darmann, New South Wales (AU)

Correspondence Address: FAY KAPLUN & MARCIN, LLP, 150 BROADWAY, SUITE 702, NEW YORK, NY, 10038, US

(73) Assignee: Zenergy Power Pty Ltd., Wollongong, NSW (AU)

(21) Appl. No.: 12/739,336

(22) PCT Filed: Oct. 30, 2008
(86) PCT No.: PCT/AU2008/001604

§ 371 Date: Apr. 22, 2010

Related U.S. Application Data
(60) Provisional application No. 60/984,448, filed on Nov. 1, 2007.

(51) Int. Cl. H02H 9/08

(52) U.S. Cl. 361/19; 361/58; 505/850

(57) ABSTRACT

A fault current limiter designed for connection into a medium voltage, high voltage, or extra-high voltage substation or other high voltage source such as a generator station, the limiter including: a ferromagnetic circuit formed from a ferromagnetic material and including at least a first limb, a second limb and a third limb; a first input phase coil wound around the first limb, a second output phase coil wound around the third limb; a saturation mechanism surrounding a limb for magnetically saturating the ferromagnetic material; a containment vessel providing a substantially uniform, low electrical conductivity medium surrounding the ferromagnetic circuit, the phase coils and the saturation mechanism.

### FIELD OF THE INVENTION

The present invention relates to the field of High Voltage Fault Current Limiters and, in particular, discloses a high voltage saturated CON fault current limiter.

### BACKGROUND OF THE INVENTION

Saturated core fault current limiters (FCLs) are known. Examples of superconducting fault current limiting devices can be seen in; U.S. Pat. No. 7,193,825 to Darmann et al; U.S. Pat. No. 6,809,910 to Yuan et al; U.S. Pat. No. 7,193,825 to Boenig; and US Patent Application Publication Number 2002/0018327 to Walker et al.

The fault current limiters described are normally suitable for use with dry type copper coil arrangements only. Indeed, the described arrangements are probably only suitable for DC saturated FCLs which employ air as the main insulation medium. That is the main static insulation medium between the AC phase coils in a polyphase FCL and between the AC phase coils and the steel core, DC coil, cryostat, and main structure is provided by a suitable distance in air. This substantially limits the FCL to a “dry type” insulation technologies. Dry type technologies normally refers to those transformer construction techniques which employ electrically insulated copper coils but only normal static air and isolated solid insulation barrier materials as the balance of the insulation medium. In general, air forms the majority of the electrical insulation material between the high voltage side and the grounded components of the device such as the steel frame work and the case.

The utilisation of dry type insulation limits the design to lower voltage ranges of AC line voltages of up to approximately 39 kV. Dry type transformers and reactors are only commercially available up to voltage levels of about 39 kV. As a result, the current demonstrated technology for DC saturated FCL's is not suitable for extension into high voltage versions. Dry type designs result in an inability to design a practically sized compact structure using air as an insulation medium when dealing with higher voltages. One of the main practical markets for FCL's is the medium to high voltage (33 kV to 166 kV) and extra-high voltage range (166 kV to 750 kV). At these voltage ranges, the currently described art and literature descriptions of DC saturated FCL's are perhaps not practical. The main reason is due to static voltage design considerations. For example, breakdown of the air insulation medium between the high voltage copper coils and the cryostat or steel care or DC coil. High voltage phase coils at medium to high voltages (greater than 39 kV) often need to be immersed in a insulating gas (such as SF6 nitrogen), a vacuum (better than 10⁻³ mbar) or a liquid such as a synthetic silicone oil, vegetable oil, or other commonly available insulating oils used in medium, high voltage, and extra-high voltage transformer and reactor technology. When a high voltage device is immersed in such an insulating medium, that medium is often referred to as the “bulk insulation medium”, or the “dielectric”. Typically, the dielectric will have a relative permittivity of the order of about 2-4, except for a vacuum which has a relative permittivity equal to 1. These so called dielectric insulation media have electrostatic breakdown strength properties which are far superior to that of atmospheric air if to employed judiciously by limiting the maximum distance between solid insulation barriers and optimising the filled dielectric distance with respect to the breakdown properties of the particular liquid or gaseous dielectric.

The commonly available bulk insulating gases and liquids typically have a breakdown strength of the order to 10 to 20 kV/min but are usually employed such that the average electric field stress does not exceed about 6-10 kV/mm. This safety margin to the breakdown stress value is required because even if the average electrostatic field stress is 6-10 kV/mm, the peak electrostatic field stress along any isostatic electric field line may be 2 to 3 times the average due to various electrostatic field enhancement effects.

In general, there are five main desirable requirements of a dielectric liquid or gas for high voltage bulk insulation requirements in housed plant such as transformers and reactors and fault current limiters:
The dielectric must show a very high resistivity,
The dielectric losses must be very low,
The liquid must be able to accommodate solid insulators without degrading that solid insulation (for example, turn to turn insulation on coil windings or epoxy),
The electrical breakdown strength must be high, and
The medium must be able to remove thermal energy losses.

Solid insulation techniques are not yet commonly available at medium to high voltages (i.e. >39 kV) for housed devices such as transformers, reactors and fault current limiters. The shortcoming of solid insulation techniques is the presence of the inevitable voids within the bulk of the solid insulation or between surfaces of dissimilar materials such as between coil insulation and other solid insulation materials. It is well known that voids in solid insulation with high voltages produce a high electric stress within the void due the field enhancement effect. This causes physical breakdown of the surrounding material due to partial discharges and can eventually lead to tracking and complete device failure.

It will be recognized that a DC saturated fault current limiter which employs a single or multiple DC coils for saturating the steel core, such as those disclosed in the aforementioned prior art, poses fundamental problems when the copper AC phase coils can no longer be of a “dry type” construction or when the main insulation medium of the complete device is air. A significant problem in such arrangements is the presence of the steel cryostat for cooling the DC HTS coil and the DC HTS coil itself. The cryostat and the coil and the steel cores are essentially at ground potential with respect to the AC phase coils.

As a side issue, but one which enhances the insulation requirements for all high voltage plant and equipment, it is normally the case that basic insulation design must also meet certain electrical engineering standards which test for tolerance to various types of over-voltages and lighting impulses over predetermined time periods. An example, in Australia, of such standards are as follows:
AS2374 Part 3. Insulation levels and dielectric tests which includes the power frequency (PF) and lightning impulse (LI) tests of the complete transformer.
AS2374 Part 3.1. Insulation levels and dielectric tests External clearances in air
AS2374 Part 5. Ability to withstand short-circuit

These standards do not form an exhaustive list of the standards that high voltage electric equipment must meet. It is recognised that each country has their own standards which cover these same design areas and reference to an individual country's standard does not necessarily exclude any other country's standards. Ideally a device is constructed to meet multiple countries standards.

Adherence to these standards result in a BIL (Basic Insulation level) for the device or a “DIL” (Design Insulation Level) which is usually a multiple of the basic AC line voltage. For example, a 66 kV medium voltage transformer or other housed device such as a FCL may have a BIL of 220 kV. The requirement to meet this standard results in a static voltage design which is more strenuous to meet practically than from a consideration of the AC line voltage only. The applicable standards and this requirement has resulted from the fact that a practical electrical installation experiences temporary over voltages which plant and devices may experience within a complex network, for example lightning over voltages, and switching surges. Hence, all equipment on an electrical network has a BIL or DIL appropriate for the expected worst case transient voltages.

An initial consideration of the static design problem for high voltage DC saturated fault current limiters may result in the conclusion that the problem is easily solved by housing only the high voltage AC copper coils in a suitable electrical insulating gas or liquid. However, the problem with this technique is that the steel core must pass through the container which holds the gas or liquid. Designing this interface for long term service is difficult to solve mechanically. However, more importantly solving the interface problem electrostatically is much more complex and any solution can be prone to failure or prove uneconomical. The problem is that as a seal must be developed between the vessel containing the dielectric fluid and the high permeance core.

Another possibility is the use of solid high voltage barriers between phases and between phases and the steel core and cryostat or a layer of high voltage insulation around the copper phase coils and in intimate contact with the phase coils. However, this has a significant deleterious side effect. It is known that the static electric field in a combination of air and other materials with a higher relative permittivity is that this always results in an enhanced electric field in the material or fluid with the lower permittivity (that is air). For example, consider a conductive copper cylinder with a layer of normal insulation to represent the turn to turn insulation, according equation 1.

$${E}_{x} = \frac{{U}_{m}}{x \cdot \{ \frac{ln [ \frac{R}{r} ]}{{ɛ}_{2} / {ɛ}_{1}} + \frac{ln [ \frac{d}{R} ]}{1} \}} \qquad Eq . 1$$

where:
Uₘ=AC phase voltage with respect to ground
R=radius of a copper cylinder including outside insulation [min]
r=radius of bare copper cylinder [mm]
d=distance from centre of cylinder to the nearest ground plane [mm]
∈₂=relative dielectric constant of the insulation covering the cylinder
∈₁=relative dielectric constant of the bulk insulation where the cylinder is immersed (=1 for air)
x=distance from the centre of cylinder to a point outside the cylinder [mm]
Eₓ=Electrostatic field gradient at point×[kV/mm]

The field enhancement effect is represented by the factor ∈₂/∈₁ and is of the order 2 to 4 for common everyday materials except for the case of employing a vacuum which has a relative permittivity equal to 1. Hence, by providing additional solid or other insulation material (of higher electric permittivity than air), one increases the electrostatic stress in the bulk air insulation of the FCL. The better the quality of the high voltage insulation, the higher the field enhancement effect.

Hence, solid dielectric insulation barriers in an otherwise air insulated FCL are not a technically desirable option for high voltage FCL's at greater than 39 kV and indeed one does not see this technique being employed to make high voltage dry type transformers at greater than 39 kV for example. In fact, no techniques have been found highly suitable to date and that is why high voltage transformers above 39 kV are insulated with a dielectric liquid or gas.

The discussion above is the reason why housed high voltage electrical equipment is often completely immersed in electrically insulating dielectric fluid or gas. That is, the insulated copper coils and the steel core of transformers and reactors are housed within a container that is then completely filled with a dielectric medium which is a fluid. This substantially reduces the electrostatic voltage design problems detailed in the above discussion. The insulating medium (for example oil, vacuum, or SF6) fills all of the voids and bulk distances between the high voltage components and the components which are essentially at ground or neutral potential. In this case, solid insulation barriers may be incorporated into the bulk insulating dielectric and for many liquids such as oil, dividing the large distances with solid insulation improves the quality of the overall electrostatic insulation by increasing the breakdown field strength of the dielectric fluid. This is because the relative permittivity of the oil and solid insulation are very close to each other (so field enhancement effects are lessened compared to air) and the breakdown voltage of the bulk dielectric medium (expressed in kV/mm) improves for smaller distances between the insulation barriers.

However, the problem with the full immersion technique is that it is not readily adaptable to a DC saturated FCL designs or other devices that incorporated a superconductor coil as the DC saturating element. This is because the superconducting coil and its cryostat or vacuum vessel are a component of the FCL which must also necessarily be immersed in the dielectric fluid.

### SUMMARY OF THE INVENTION

It is an object of the present invention to provide for an improved construction of a High Voltage Fault Current Limiter.

In accordance with, a first aspect of the present invention, there is provided a fault current limiter designed for connection into a medium voltage, high voltage, or extra-high voltage substation or other high voltage source such as a generator station, the limiter including: a ferromagnetic circuit formed from a ferromagnetic material and including at least a first limb, a second limb and a third limb; a first input phase coil wound around the first limb, a second output phase coil wound around the third limb; a saturation mechanism surrounding a limb for magnetically saturating the ferromagnetic material; a containment vessel providing a substantially uniform, low electrical conductivity medium surrounding the ferromagnetic circuit, the phase coils and the saturation mechanism.

The medium can comprise a vacuum of better than 10-3 mBar. Alternatively, the medium can comprise a dielectric medium such as SF6, Nitrogen gas, synthetic silicon oil, or vegetable oil. The medium can also comprise a cryogenic liquid or gas. The saturation mechanism preferably can include a superconducting DC coil. The superconducting DC coil can be supported on a base of low thermal conductivity material. The saturation mechanism preferably can include a superconducting coil located in a cryostat. The cryostat preferably can include an external thermal insulation blanket. The saturation mechanism preferably can include a mechanical hold support formed from a lower thermal conductivity material.

The phase coils are preferably formed from a copper winding having an enlarged cross-section of conductor relative to standard phase coils for carrying an expected current. The ferromagnetic material can comprise a laminated steel core.

The direct current coil can comprise a superconductive coil and the limiter further preferably can include an encased superconductive cooling means surrounding the superconductive coil. The phase coils are preferably superconducting coils. The limiter preferably can include three phases on separate ferromagnetic circuits. The source voltage can exceed 37 kV.

The superconducting DC coil can be surrounded by a coil containing a cryogenic fluid or gas. The cryogenic fluid or gas can be supplied from an external source to the limiter. There are preferably redundant supply sources for the fluid or gas.

In accordance with a further aspect of the present invention, there is provided a fault current limiter designed to handle a high voltage source, the limiter comprising: a ferromagnetic circuit formed from a ferromagnetic material and including at least a first limb, a second limb and a third limb; a first input phase coil wound around the first limb, a second output phase coil wound around the third limb; a direct current coil wound around the second limb for saturating the ferromagnetic circuit during normal use; a vacuum vessel surrounding the ferromagnetic circuit and maintaining the circuit in a vacuum.

The direct current coil can comprise a superconductive coil and the limiter further preferably can include an encased superconductive cooling means surrounding the superconductive coil.

### BRIEF DESCRIPTION OF THE DRAWINGS

Preferred embodiments of the invention will now be described, by way of example only, with reference to the accompanying drawings in which:

FIG. 1 illustrates a side perspective cut away view of an initial embodiment of the present invention for a 3 phase system;

FIG. 2 illustrates a side perspective cut away view of an alternative embodiment of the present invention;

FIG. 2a illustrates a close up cut away view of the DC coil of FIG. 2;

FIG. 3 illustrates a side perspective cut away view of a further alternative embodiment of the preferred embodiment;

FIG. 3a illustrates a close up cut away view of the DC coil of FIG. 3;

FIG. 4 illustrates a side perspective cut away view of a further alternative embodiment of the preferred embodiment;

FIG. 5 illustrates a side perspective cut away view of a further alternative embodiment of the preferred embodiment;

FIG. 6 illustrates a side perspective cut away view of a further alternative embodiment of the preferred embodiment;

FIG. 7 illustrates a side perspective cut away view of a further alternative embodiment of the preferred embodiment, and

FIG. 8 illustrates a simulated response of a circuit when a FCL is used an when one is not used.

### DESCRIPTION OF PREFERRED AND OTHER EMBODIMENTS

In the preferred embodiments there is provided a high voltage DC saturated FCL which do not suffer substantially from the bulk insulation problems discussed above.

Design 1. High Voltage DC Saturated FCL with a Dry Cryo-Cooled DC Coil

In a first embodiment, there is provided a high voltage DC saturated FCL with a dry cryo-cooled DC coil. Three alternative embodiments will be discussed.

1. Full Vacuum Insulated Design with a Dry Cryo-Cooled High Temperature DC Coil

A first embodiment will now be discussed. It will be recognised that many specific different possible configurations of this embodiment are technically feasible. For example, a single phase version may be constructed in an analogous way. In addition, multiple single phase versions substantially of the same design and construction may be placed side by side to form a three phase device.

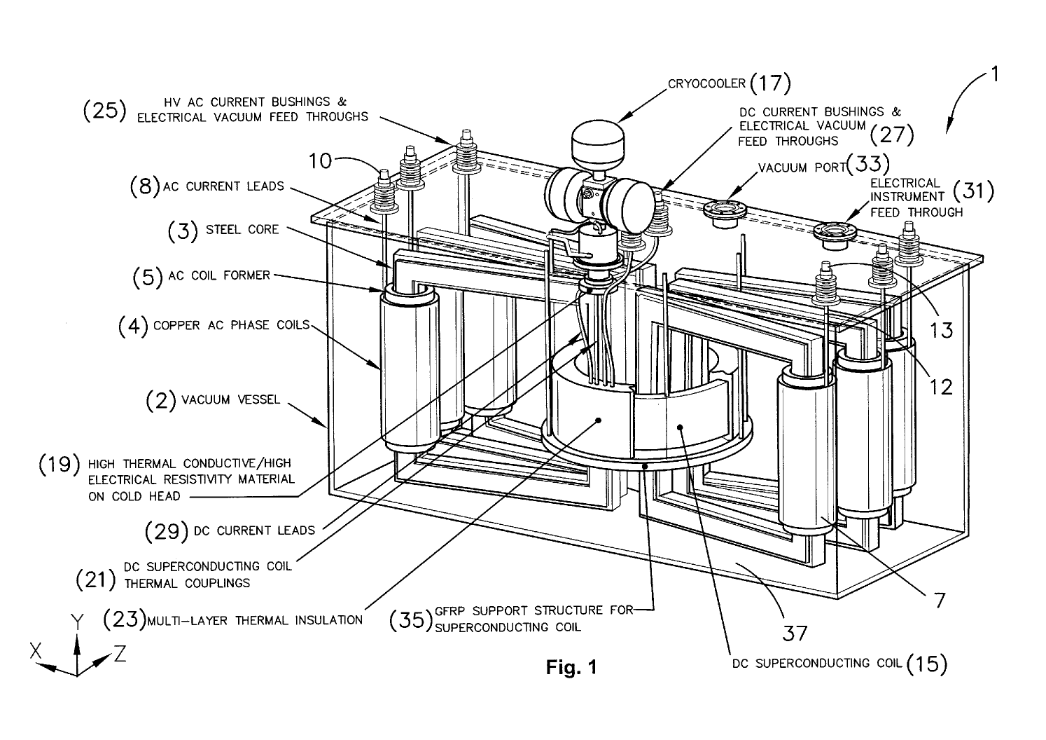

Turning initially to FIG. 1, there is illustrated a first embodiment 1 of a DC saturated fault current limiter. The FCL 1 includes a single vacuum vessel 2 in which the complete DC saturated FCL (of a design similar to that disclosed in U.S. Pat. No. 7,193,825) is placed. Ideally, the vacuum level must not be of a magnitude such that the phenomenon of glow discharge occurs (between 0.1 and 1 milliBar) and must be such that the dielectric breakdown strength of the vacuum is better than that of atmospheric air. Otherwise, no advantage in the electrostatic design would be obtained. Hence, a vacuum level in the main vessel housing of better than 0.001 millibar, as indicated by the Paschen curve [Paschen, Wied. Annalen der Physik, 1889.37: pp. 69-75] is ideally obtained for a significant gain in the practical electrostatic design.

The FCL illustrated comprises a multiphase arrangement with each phase including a laminated steel core e.g 3 which acts to concentrate the magnetic flux as is previously described. Around each core is wound a copper AC phase coil e.g. 4 which can be wound on a coil former 5. Each phase of the FCL has an input phase coil e.g. 4 connected to a current lead e.g. 8 which is in turn connected to a HV AC current Bushing and vacuum feed through e.g. 10, in addition to an output phase coil e.g. 7 connected to an output current lead 12 and HV AC current Bushing and vacuum feed through 13.

The conventional copper or aluminium AC phase coils e.g. 4, 7 can be coils manufactured from an electrically conductive material which may be insulated with solid insulation material or left un-insulated.

Each of the laminated steel cores e.g. 3 have a generally rectangular shape and are arranged around a DC superconducting coil 15 which acts to saturate the FCL steel cores during normal operation (as described in more detail in U.S. Pat. No. 7,193,825). Whilst the core 15 could be resistive, preferably the core 15 is a superconducting DC coil. The phase coils are interconnected in such a manner as to form a DC saturated fault current limiter

A cryocooler 17 is provided and can be of a pulse tube or other type of cryo cooler and includes a cold head 19 which protrudes into the vacuum space of vacuum vessel 2 as per conventional integration techniques. Ideally, a sufficiently thick layer of high thermal conductivity high resistivity material coats the cold head 19 for the purposes of thermally anchoring the DC coil and current leads yet also providing electrical insulation

A thermal interface of high thermal conductivity material 21 connects the cryo cooler cold head to the DC superconducting coil. The preferred form of thermal interface between the cold head of the cryocooler and the superconducting DC coil which consists of flexible braided copper wire rope made from fine strands of copper.

The preferred embodiment has a sufficiently thick blanket insulation layer 23 of MLI (multi-layer insulation) such as aluminised Mylar layers or equivalent materials wrapped around the DC superconducting coil.

The high voltage Electrical vacuum feedthrough bushings e.g. 25 are employed to carry the AC phase current. Six such AC phase coil bushings are required for the embodiment 1 of FIG. 1, which is a three phase device. These bushings are commercially available from several companies. Two low voltage DC current electrical vacuum feedthrough bushings e.g. 27 are employed to supply the DC saturating coil 15 via leads e.g. 29. These bushings are also of a standard type, commercially available from several companies,

An additional electrical vacuum feedthrough is provided 31 for the purposes of bringing temperature monitoring and sensing signals to the outside of the vacuum vessel. Pressure and temperature sensors can be provided on coils and steel core as required. Feedback from the pressure and temperature sensors can be provided to a cryocooler PID control unit.

A vacuum pump port 33 is provided for interconnecting a vacuum pump (not shown) for the purpose of evacuating the vacuum vessel 2.

The arrangement also includes solid insulation between the phase coils and the steel core in the form of an AC coil former 5. The steel core and phase coils are held in place by a mechanical holding structure (not shown).

In one arrangement of a FCL 1, the design can include:
The number of AC phase coil turns is 20 on each of the six limbs,
The number of DC coil turns is 5600,
The DC bias current is 100 Amps,
The AC voltage source is 138 kV line to line rms at 60 Hz,
The core cross sectional area of permeable material is 0.05 square meters,
The steady state insertion impedance of the FCL is 1 milliOhm at 60 Hz,
The desired steady state fault current reduction≈70% of prospective steady state fault current (30% reduction)

The arrangement 1 allows a high voltage DC saturated FCL with HTS coil to be assembled.

It will also be recognised that the listed parameters are a particular case only and that many variations exist depending on whether mass, footprint, or cost needs to be minimised or optimised.

Various standard additional equipment can be provide for the arrangements in the figures. For example, high voltage electrostatic and creep extension barriers and other electrostatic insulation structures can be provided but are not shown in the figures for the sake of clarity. As a further example, electrostatic corona rings on the AC coils, insulation extensions on the dielectric side of the bushings covering the phase coil lead conductors, phase-to-phase electrostatic insulation barriers, phase to superconducting coil and cryostat electrostatic insulation barriers, and phase-to-ground electrostatic insulation barriers must be provided and integrated within the design according to the electrostatic, stress distribution pattern, the phase voltage employed, the DIL, the maximum electric stress found within the vessel at sharp corners, and the maximum creep stress across the surfaces. The insulation barriers can be manufactured from suitable insulation materials which are compatible with the dielectric insulating fluid. These aspects are common to the prior art and are common knowledge to high voltage transformer designers. For example, if oil is used as the main bulk insulation fluid, then readily available paper based pressboard may be employed to manufacture the electrostatic barriers from the phase-to-phase and from the phase to any other objects at ground potential. These are available in the shape of cylinders for around the cryostat and the copper coils and are employed to divide the bulk dielectric insulation space between high voltage and low voltage components into distances which are suitable for the phase voltage, the voltage stress contours, and the dielectric under consideration.

It is noted that the vacuum, while having some advantages, is a poor thermal conductor. However, the arrangement of FIG. 1 allows for the complete FCL (including a superconducting DC coil acting as the saturating coil) to be immersed in the vacuum. The DC superconducting coil 15, cooled by the cryo cooler 17, is thermally insulated from the ambient surroundings outside of the vacuum vessel and is electrically insulated from the copper coils and therefore can remain superconducting. No vacuum insulated cryostat for the DC superconducting coil is required (as would normally be the case. The MLI blanket 23 is employed to reduce the thermal radiative emission component from the ambient surroundings outside the vacuum vessel and from the steel core and copper coils and therefore reduce the burden on the cryocooler.

The copper AC phase coils e.g. 4 may require cooling. In the arrangement 1, the proportion of copper in terms of mass and cost is less than about 2% of the total device cost and less than 3% of the total device mass. Of course, the actual percentages differ according to specific design particulars, however, it will be appreciated that the copper quantity and cost is of lower economic consideration. Hence doubling the cross section of the copper conductor employed to form the copper phase coils from the usual engineering requirement based on thermal considerations alone will reduce the thermal heat load by a factor of four with minimal cost, mass, and size implications. In this manner, the normal radiative cooling mechanism is sufficient for thermal stability of the steel core 3.

Another concern is the cooling of the steel core e.g. 3. In a DC saturated FCL, the steady state steel core loss is not calculated from the hysteresis curve of the steel core but from the minor hysteresis loop at the bias point. The steady state loss of a saturated steel core are likely to be less than 2% of the AC hysteresis loss. The small amount of power loss in the steel core combined with the relatively large surface area of the steel core results in sufficient cooling from the radiative component alone such that the steady state temperature of the core is within the limit for practical steel core constructions. Hence, the radiative cooling mechanism is sufficient for thermal stability of the steel core.

It will be recognised that the precise steel core loss depends on the mass of steel present, the bias point, and the details of the type of steel used in the core. The final temperature of the steel core and copper coils in the vacuum vessel in the steady state will depend on the surface area. However, these are design details for which well established equations and other tools/methodologies such as FEA exist and which should be calculated in detail during the design or commissioning process.

The mechanical holding support 35 for the DC superconducting coil is manufactured from a low thermal conductivity material such as glass fibre reinforced plastic (GFRP). This provides effective thermal insulation from the vacuum walls and supporting structures which are at ambient or a higher temperature. The mechanical holding structure 37 for the steel care may be manufactured from a material with a high thermal conductivity and may be bonded to the vacuum vessel shell so as to form a thermal short circuit. The mechanical holding structure including the AC Coil Formers e.g. 5 for the phase coils may be manufactured from material with a high thermal conductivity and a very low electrical conductivity (i.e. an electrical insulator) and the mechanical holding structure may be bonded to the vacuum vessel shell so as to form a thermal short circuit. The turn to turn and layer to layer electrical insulation of the AC coil phase windings can be insulated with an electrical insulation material which can withstand high temperatures. For example Nomex™, glass fibre, glass fibre epoxy composite, Mica, Teflon, Kapton™, or other similar materials may be utilised.

In another alternative embodiment, multiple independent cryo-coolers may be integrated into the design to provide redundancy of cooling for critical applications such as at sub-stations.

### Design 2. A Cryogenic Liquid Cooled High Voltage FCL

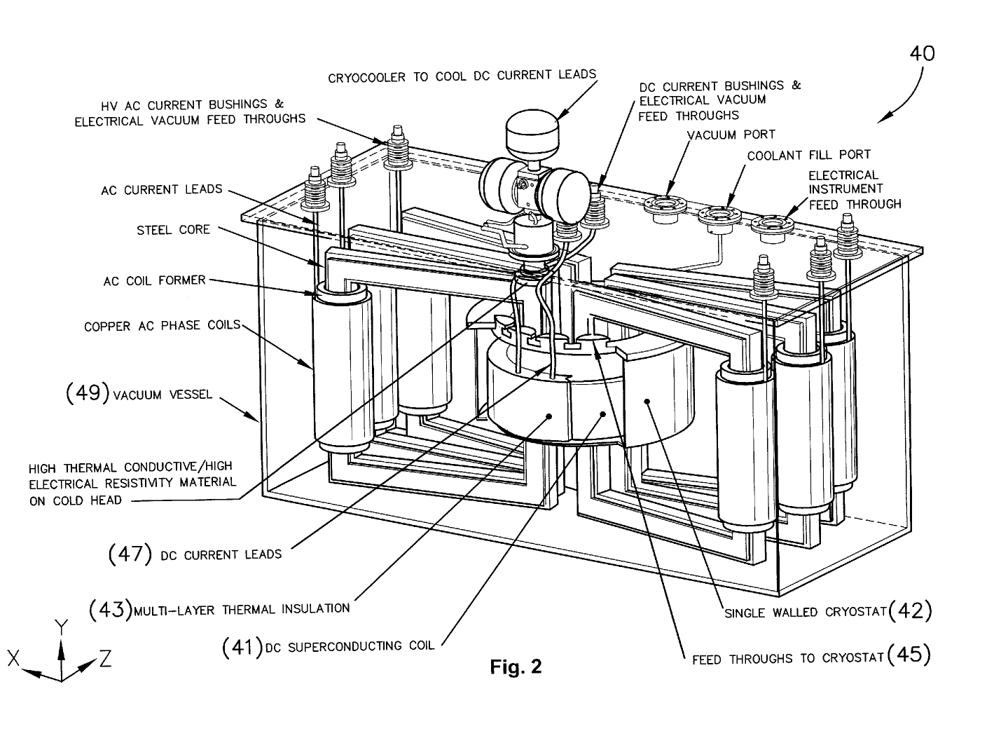

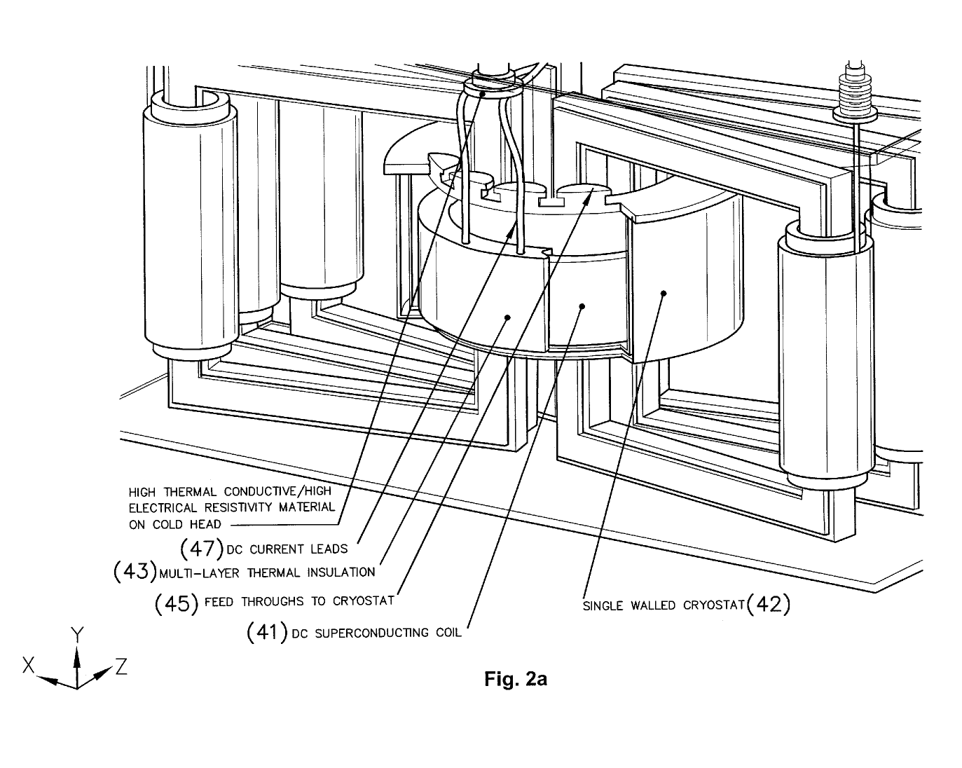

The arrangement of FIG. 1 may not be immediately suitable for cooling a DC superconducting coil with cryogenic liquids and gases. Cooling with cryogenic liquids and gases offers many operational advantages over mechanical cooling methods. A further variation of the arrangement of FIG. 1 will now be described which is to substantially more suitable for the practical incorporation of cryogenic liquid or gas cooling of a DC superconducting coil component. The construction will be described with reference to the cut away view of FIG. 2.

The arrangement of FIG. 2 is substantially similar to that of FIG. 1. However, in this arrangement 40, the DC coil 41 is housed in a separate single walled enclosed vacuum tight chamber or cryostat 42 and filled with a cryogenic fluid such as liquid or gaseous Nitrogen, liquid or gaseous Neon, or liquid or gaseous Helium for the purposes of cooling the superconducting DC coil. A MLI thermal blanket is placed around the superconducting DC coil on the inside surface of the smaller vacuum vessel 42.

Now it will be recognised that such a construction will require additional feedthoughs 45 on the DC coil cryostat to pass the DC electrical current 47, instrumentation, and thermal coupling leads from the vacuum environment of the main housing vessel into the cryogenic environment of the DC coil cryostat 42,

In this high voltage FCL design, it can be seen that an alternative means of providing cryogenic cooling for the DC superconducting coil 41 is provided. The main vessel 49 in which the FCL construction is housed remains under vacuum so the vessel 42 holding the liquid nitrogen only needs to be single walled, it does not need a vacuum insulated wall because the ambient conditions are already under vacuum and provide the thermal insulation from the outside atmospheric ambient conditions. The thermal blanket 43 remains in order to shield the coil from radiative heat coming from the AC phase coils, the steel core, and the vacuum vessel in which the FCL structure is housed.

FIG. 2a is a close up cut away view of the cryostat of FIG. 2 illustrating the cryostat in more detail.

### Design 3. Cryogenic Liquid Cooled DC Coil and AC Phases/Core in a Separate Dielectric Medium

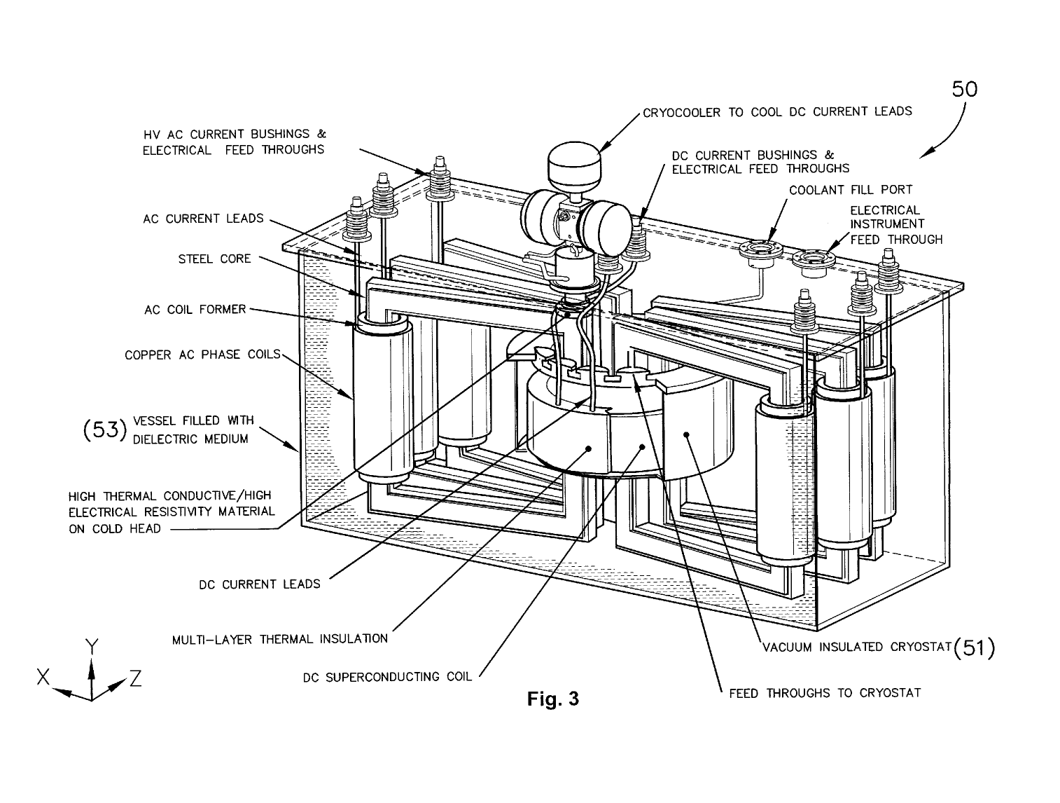

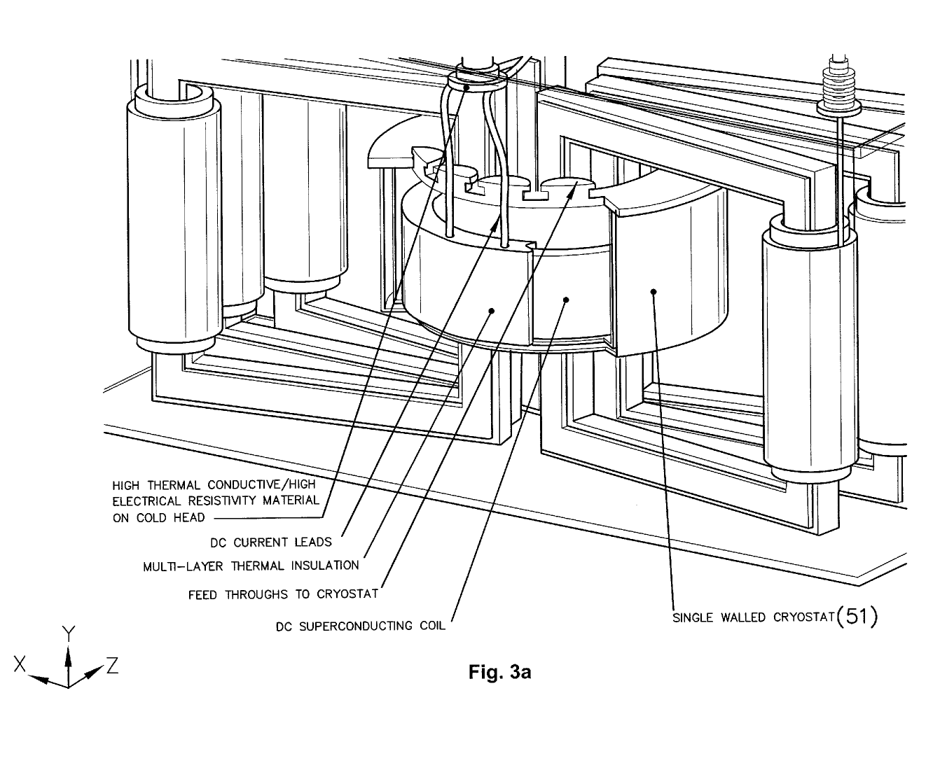

In another alternative embodiment, illustrated 50 in the cut away view in FIG. 3, a DC saturated FCL of a similar construction to FIG. 1 and FIG. 2 is provided, but with the DC saturating coil housed in a separate vacuum insulated cryostat 51 which can be filled with a cryogenic fluid such as liquid nitrogen. The vessel 53 in which the construction is immersed is filled with a dielectric medium such as SF6, Nitrogen gas, synthetic silicon oil, vegetable oil, or other suitable dielectric media for high voltage applications. In the arrangement 50, solid insulation electric stress barriers can be employed between the phase coil pairs and between the AC phase coils and the cryostat, so as to divide the bulk dielectric insulation into narrow channels.

FIG. 3a is a close up cut away view of the cryostat of FIG. 3 illustrating the cryostat in more detail.

### Design 4. Completely Immersed DC Saturated FCL for High Voltage Applications

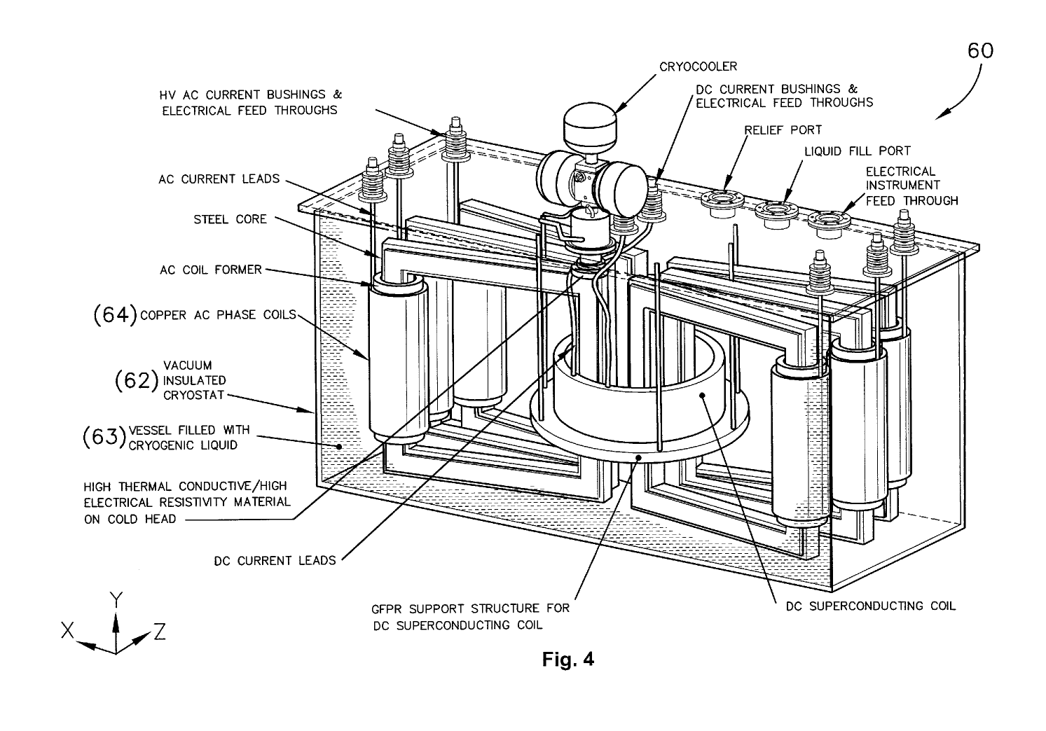

In a further alternative embodiment, illustrated 60 in FIG. 4, the entire FCL of the preferred embodiment described in FIG. 1 is immersed in a suitable cryogenic liquid, where the cryogenic liquid is also a good dielectric, such as liquid Nitrogen, liquid Neon, or liquid Helium. In this design variant, the vessel which houses the complete FCL is replaced with a vacuum insulated cryostat 62 and the vessel which housed the DC coil only (as in Design variant 2 and 3) is no longer required.

The cryogenic liquid 63 may be at ambient pressure (i.e. pool boiling liquid) or at a sufficiently low pressure such that the cryogenic liquid is sub-cooled. The cryogenic liquid may be maintained by any of the standard solutions that exist such as placing the cold head directly in the top gaseous void, piping gas off to a re-liquefier, or a complete loss/replenishment system.

It should be noted that the AC phase coils 64 in the design 60 of FIG. 4 are not superconducting in the cryogenic dielectric and hence there are potentially significant electrical losses in the dielectric liquid which need to be removed by the cryogenic replenishment system. However as previously described, the cast and mass of the AC phase coil winding are of less significance as parameters to the economic and technical considerations of a DC saturated FCL. In addition, the electrical losses of a conventionally conducting electromagnetic coil follow substantially the inverse of the cross sectional area of the conductor. Hence, the AC phase coil windings can be designed to have a suitable conductor having an over sized cross sectional area compared to normal requirements were one to choose a cross-section from consideration of losses to ambient conditions only.

In this design variation, the cryogenic replenishment system can consists of either a total loss system, a cryo cooler with the cold head placed inside the vessel, or a gas re-liquefaction system.

Design 5. Completely Immersed DC Saturated FCL with Superconducting AC Coils

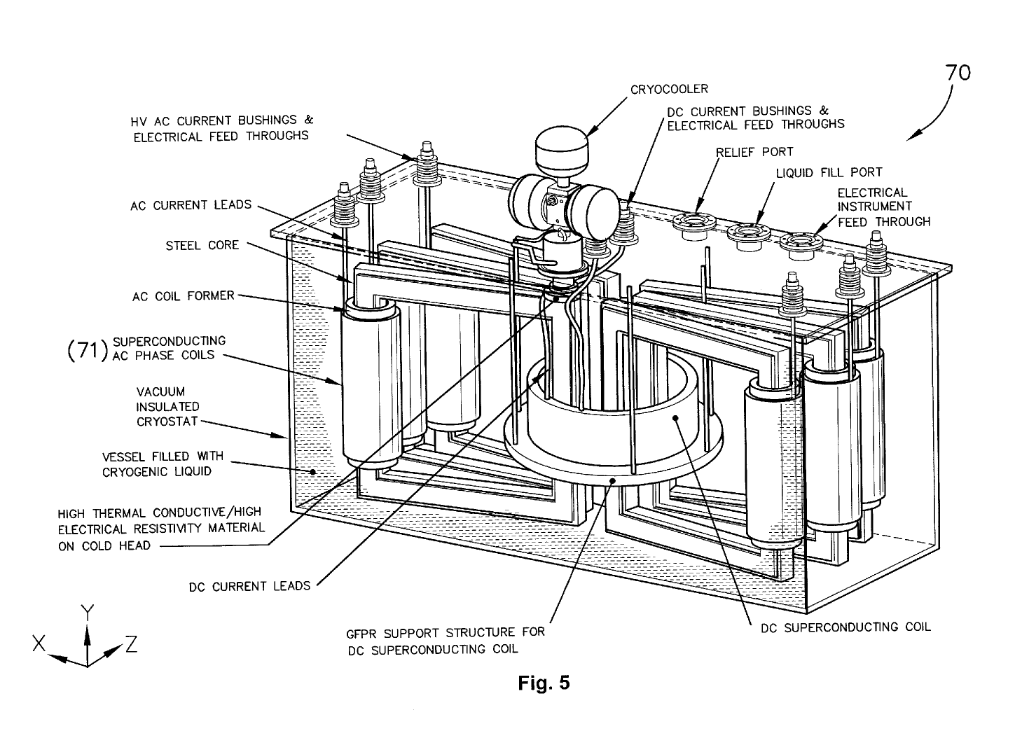

In a further varied embodiment, illustrated in the cut away view of FIG. 5, the AC phase coils of Design 4 are replaced with superconducting coils 71 and the entire FCL (consisting of the main components of a core, AC phase coils, and a DC coil) is immersed in a cryogenic liquid substantially as in the Design 4 variant. Further, in this arrangement, the clyocooler is directly coupled to the top of the cryostat.

One issue with this design may be the joule heating due to AC losses of the superconductor and the energy losses of the core and having to provide sufficient cooling power to compensate for those losses. However, three inherent design elements of the DC saturated core FCL make this design variant a practical method of manufacturing a high voltage FCL. These include:
1) The fact that there are only a few turns required to manufacture the AC phase coils unlike in a superconducting transformer In the design of FIG. 1, the amount of HTS superconducting conductor required to manufacture the six phase coils is less than 600 m. This is based on the assumption that the self field critical current of the HTS conductor equals 240 Amps at 77K. The superconductor winding could be designed to have an average AC loss of less than 0.01 Watts per meter of superconducting conductor and hence the total loss for all six phase coils would be of the order of 6 Watts at 77 Kelvin for example. This would take just of the order of 100 Watts of wall power at room temperature to remove which is entirely practical and economically achievable,
2) The FCL core is biased well into saturation and hence steady state core losses are due to excursions around the minor hysteresis loop, not the full hysteresis loop of the core.
3) At the cryogenic temperatures, the penetration depth of the eddy current into the thin laminations of the steel core at power frequencies is such that eddy current losses are an order of magnitude less than at room temperatures.

### Design 6. Extra High Voltage DC Saturated FCL

The particular designs shown in the previous figures may not be specifically suitable for extra high voltage duty. In particular, the two different phase coils are in close proximity in these figures. Of course the arrangement of the iron cores may be re-configured as appropriate to the foot print constraints or other physical and technical constraints for each particular application.

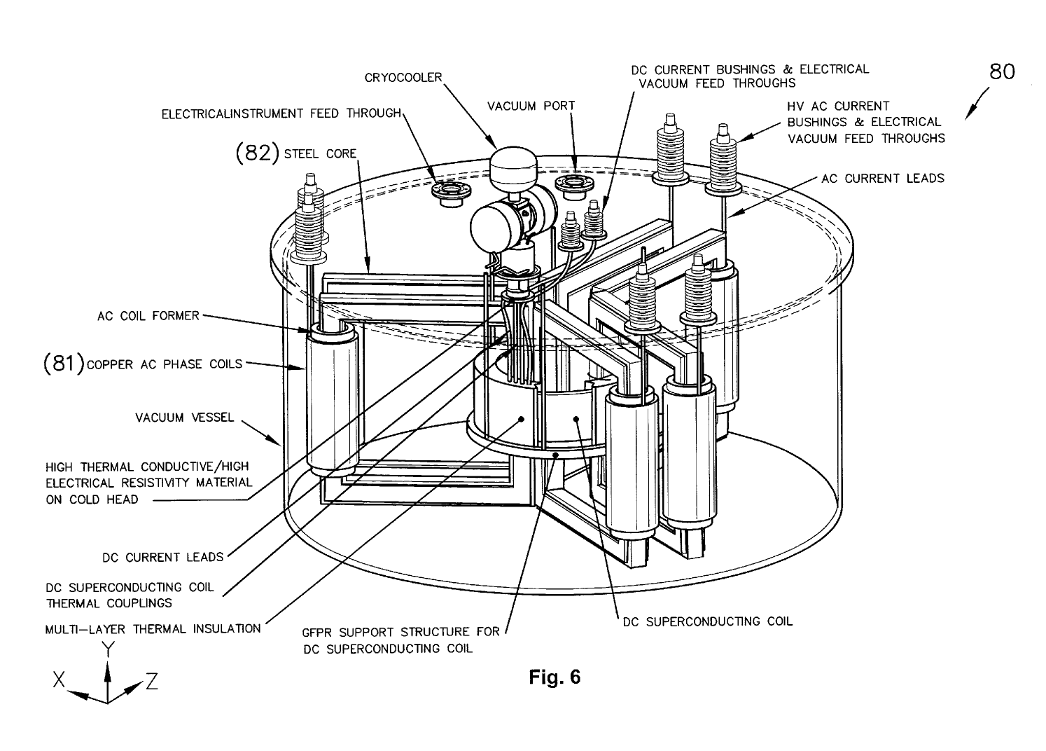

Turning now to FIG. 6, there is illustrated a cut away view of one design 80 for an extra high voltage FCL. In the arrangement 80, each pair of core limbs 81 and pairs of AC phase coils 82 are placed at the maximum distance from each other. It should be noted that each of the design variations described here (that is as illustrated in FIG. 1 to FIG. 5) can also be applied to the extra high voltage design described in FIG. 6. Each one has its economic and technical design advantages and disadvantages.

For example, the arrangement 80 shown in FIG. 6, may be superconducting and housed in a cryostat and that cryostat filled with a cryogenic liquid.

In a further modified embodiment, the balance of the FCL vessel may additionally be filled with a dielectric gas. In a further modified embodiment, the FCL housing can be a vacuum insulated cryostat filled with a cryogenic liquid dielectric or gas (such as Nitrogen, Neon, or Helium) and the complete FCL immersed in the cryogenic medium. In another embodiment, the AC phase coils are additionally superconducting.

In alternative arrangements, the cryocooler may be placed remotely relative the FCL. For example, in such an arrangement, gaseous Nitrogen (or other) transfer pipes could be connected from the top of the FCL and the gas can be re-condensed to the cryogenic liquid in a remote tank with a similar cryocooler as shown in the figures. That tank can be continuously replenishing the cryostat/vessel with liquid cryogen.

### Design 7. Re-Circulating Gas Cooled High Voltage and Extra-High Voltage Fault Current Limiter.

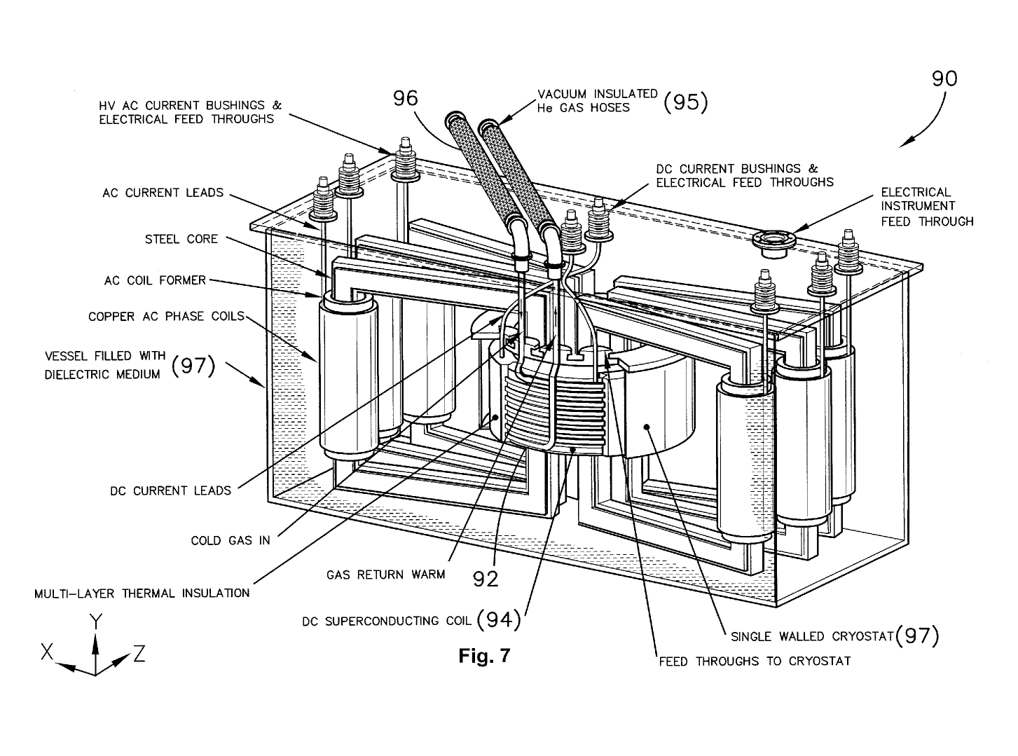

A design for a forced He gas cooled high voltage or extra high voltage FCL is shown 90 in FIG. 7.

The vessel 91 holding the Superconducting coil may be manufactured from a suitable material such as stainless steel, plastic, or glass fibre reinforced plastic. The tubes 92 wrapped around the Superconducting coil contain the cooling medium and are in good thermal contact with the Superconducting coil and may be manufactured from copper or other material which is capable of good thermal contact with the Superconducting coil. Heat transfer occurs from the Superconducting coil 94 into the cold re-circulating fluid 92.

The re-circulating fluid 92 may be any suitable cryogenic liquid or gas but the design is particularly suited to 20 Kelvin Helium gas, 30 Kelvin Neon, or 77K liquid nitrogen. The fluid is fed via vacuum insulated hoses 95, 96. The complete vessel 97 holding the insulating fluid and the vessel containing the superconducting coil is filled with a dielectric medium as referred to previously.

The advantage of this design is that the cryostat containing the FCL coil only needs to be a single walled vacuum vessel which simplifies the overall design of the FCL.

This design is particularly suited to an all plastic cryostat which simplifies the electrostatic design of the complete device because the cryostat itself will form an additional electrical stress insulation barrier between the high voltage AC phase coils and the low voltage superconducting coil. This enables a more compact high voltage design compared to the case where the cryostat were manufactured from stainless steel.

It will be recognised that elements and features of the previous preferred embodiments (FIG. 1-6 inclusive) may be applied to this design. For example, the AC phase coils may be superconducting and the dielectric medium may be a cryogenic fluid such as those referred to previously. In particular, the arrangement of the cores in design 6 (FIG. 6) will be desired when an extra high voltage version of the design in FIG. 7 is required.

In general, by employing a remote liquefication method, redundancy and maintenance may be easier to realize. For example, if two cryo coolers and two storage tanks were employed, and if these were located remotely to the FCL, then maintenance may be performed on one cryocooler while the other remains working. In this way, the FCL can remain live, in circuit, and functional/operational during cryocooler maintenance or repair activities and there is no need to switch out the FCL if this approach is employed.

In the preferred embodiments, the cryostat can be constructed from a number of materials including stainless steel, Glass Fibre Reinforced Plastic, G10, G11 or other polymeric material. Further, where required, these materials can be utilised for the electrical vacuum feed through fittings and the vacuum fittings which are on top of the cryostat.

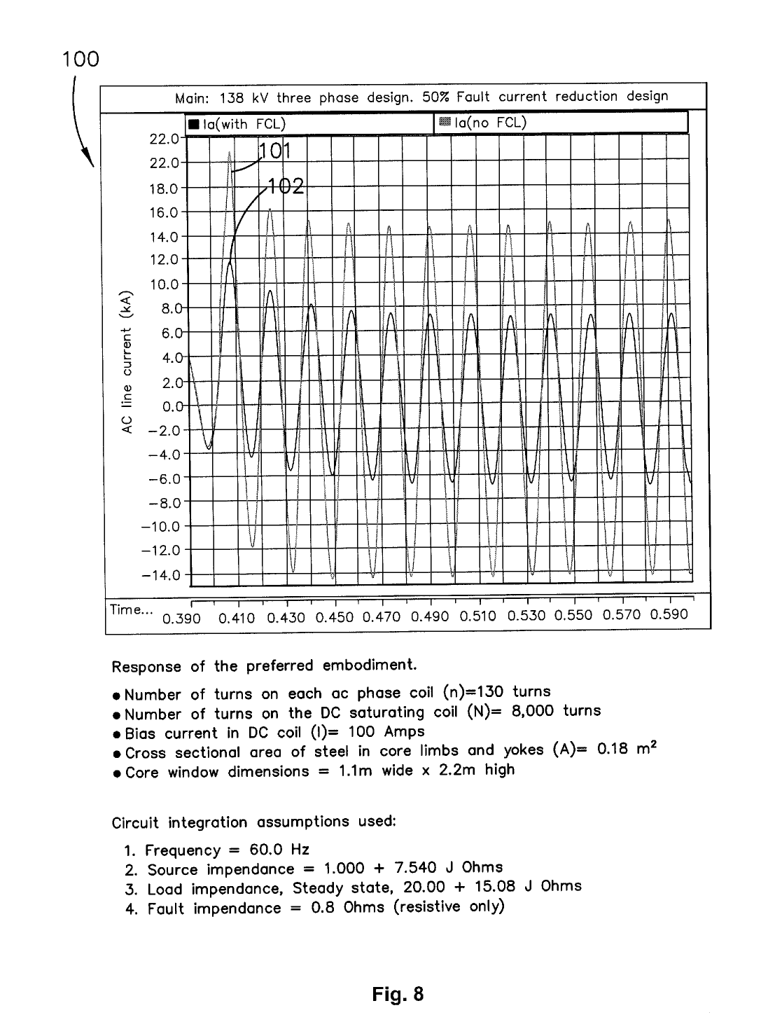

Turning now to FIG. 8, there is illustrated a simulation result 100 for a 138 kV three phase design. The simulation was directed to the arrangement of FIG. 1 and includes the following design parameters;
Number of turns on each ac phase coil (n)=130 turns
Number of turns on the DC saturating coil (N)=8,000 turns
Bias current in DC coil (I)=100 Amps
Cross sectional area of steel in the core limbs and yokes (A)=0.18 m²
Core window dimensions=1.1 m wide×2.2 m high

Circuit integration assumptions used;
1) Frequency=60.0 Hz
2) Source impedance=1.000+7.540 J Ohms
3) Load impedance, Steady state, 20.00+15.08 J Ohms
4) Fault impedance=0.8 Ohms (resistive only)

A first curve 101 shows the resulting fault current where no FCL was present and a second curve 102 shows the fault current where the FCL is present. It can be seen from the simulation that the design works effectively as a fault current limiter.

It should also be recognised that the designs presented here include all of the advantages bestowed upon a practical fault current limiter that are described in the prior art relating to DC saturated fault current limiters. In particular, these include: low stand by core losses due to the saturated state of the high permeability core of the fault current limiter, a low terminal impedance [eg. U.S. Pat. No. 7,193,825 to Darmann et al], simplicity of design as the main structure employs construction techniques which are well known to transformer and reactor manufacturers, if employing a Superconducting coil for the saturating element, then the designs presented here exhibit low AC losses compared to alternative Superconducting FCL's because the coil is carrying a DC current only, simplicity of the cryogenic vessel design as the Superconducting coil is at low voltage, and not stressed to the main phase voltage of the ac lines, simplicity of the mechanical support for the superconductor element as the AC line fault current is not carried by the superconducting coil and simplicity of the cryogenic cooling and safety procedures for the Superconducting coil as the AC line fault energy is not dumped into the cooling medium.

The forgoing describes preferred features of the present invention. Modifications, obvious to those skilled in the art can be made thereto without departing from the scope of the invention.

1-22. (canceled)

23. A fault current limiter, comprising:
a ferromagnetic circuit formed from a ferromagnetic material and including at least a first limb, a second limb and a third limb;
a first input phase coil wound around the first limb, a second output phase coil wound around the third limb;
a magnetic saturation mechanism surrounding a limb for magnetically saturating the ferromagnetic material; and
a containment vessel providing a substantially uniform, low electrical conductivity medium surrounding the ferromagnetic circuit, the phase coils and the saturation mechanism.

24. A limiter as claimed in claim 23, wherein the limiter is configured for connection into a voltage substation.

25. A limiter as claimed in claim 23, wherein the low electrical conductivity medium comprises a vacuum of better than 10⁻³ mBar.

26. A limiter as claimed in claim 23, wherein the low electrical conductivity medium comprises a dielectric medium.

27. A limiter as claimed in claim 26, wherein the medium includes one of SF6, Nitrogen gas, synthetic silicon oil, and vegetable oil.

28. A limiter as claimed in claim 23, wherein the medium comprises one of a cryogenic liquid and gas.

29. A limiter as claimed in claim 23, wherein the magnetic saturation mechanism includes a superconducting DC coil.

30. A limiter as claimed in claim 29, wherein the superconducting DC coil is supported on a base of low thermal conductivity material.

31. A limiter as claimed in claim 29, wherein the saturation mechanism includes a superconducting coil located in a cryostat.

32. A limiter as claimed in claim 28, wherein the cryostat includes an external thermal insulation blanket.

33. A limiter as claimed in claim 31, wherein the cryostat is formed of plastic walls.

34. A limiter as claimed in claim 23, wherein the phase coils are formed from a copper winding having an enlarged cross-section of conductor relative to standard phase coils for carrying an expected current.

35. A limiter as claimed in claim 23, wherein the saturation mechanism includes a mechanical hold support formed from a lower thermal conductivity material.

36. A limiter as claimed in claim 23, wherein the ferromagnetic material comprises a laminated steel core.

37. A limiter as claimed in claim 23, wherein the direct current coil comprises a superconductive coil and the limiter further comprising:
an encased superconductive cooling arrangement surrounding the superconductive coil.

38. A limiter as claimed in claim 23, wherein the phase coils are superconducting coils.

39. A limiter as claimed in claim 23, wherein the limiter includes three phases on separate ferromagnetic circuits.

40. A limiter as claimed in claim 23, wherein the source voltage exceeds 37 kV.

41. A limiter as claimed in claim 29, wherein the superconducting DC coil is surrounded by a coil containing one of a cryogenic fluid and gas.

42. A limiter as claimed in claim 41, wherein one of the cryogenic fluid and gas is supplied from an external source to the limiter.

43. A limiter as claimed in claim 42, wherein one of the cryogenic fluid and gas is supplied by redundant supply sources.

44. A fault current limiter, comprising:
a ferromagnetic circuit formed from a ferromagnetic material and including at least a first limb, a second limb and a third limb;
a first input phase coil wound around the first limb, a second output phase coil wound around the third limb;
a direct current coil wound around the second limb for saturating the ferromagnetic circuit during normal use; and
a vacuum vessel surrounding the ferromagnetic circuit and maintaining the circuit in a vacuum.

45. A limiter as claimed in claim 44, wherein the limiter is configured to handle a high voltage source.

46. A limiter as claimed in claim 44, wherein the direct current coil comprises a superconductive coil and the limiter further comprising:
an encased superconductive cooling arrangement surrounding the superconductive coil.
